(19) United States
(12) Patent Application Publication
(10) Pub. No.: US 2026/0152661 A1
(43) Pub. Date: Jun. 4, 2026

(54) FDA-COMPLIANT TANK LINING

(71) Applicant: SWIMC LLC, Cleveland, OH (US)

(72) Inventors: Adlai J. PERRY, North Olmsted, OH (US); Sachin S. CHAVHAN, Reminderville, OH (US)

(21) Appl. No.: 18/741,912

(22) PCT Filed: Dec. 20, 2022
(86) PCT No.: PCT/US2022/081989

§ 371 Date: Jun. 13, 2024

Related U.S. Application Data
(60) Provisional application No. 63/265,742, filed on Dec. 20, 2021.

(51) Int. Cl. C09D 163/00

(52) U.S. Cl. CPC C09D 163/00

(57) ABSTRACT

A two-part epoxy coating composition for producing an adherent and flexible coating for articles such food commodity storage tanks. The two-part epoxy coating composition includes a first component comprising a polyepoxide and a second component comprising a curing agent blend capable of reacting with the polyepoxide under ambient conditions. The composition can be sprayed on to a substrate at ambient or low temperatures and the cured coating demonstrates optimal flexibility while adhering to the FDA 175.300 standard.

### BACKGROUND OF THE INVENTION

Protective coatings are often applied to the interior of articles such as holding tanks, vessels, rail cars, bulk storage containers, pipes, valves, and other storage articles or systems. In the case of potable water and or food contact applications as well as others, there is a potential for the coating system to leach compounds from the coating into the water or foodstuff contained therein.

Various coatings compositions have been used as adherent coatings, including polyvinyl-chloride-based coatings and epoxy-based coatings incorporating 4,4-(propane-2,2-diyl)diphenol, e.g., bisphenol A (BPA). Each of these coating types, however, has potential shortcomings. For example, the recycling of materials containing polyvinyl chloride or related halide-containing vinyl polymers can be problematic. There is also a desire by some to reduce or eliminate certain BPA-based compounds commonly used to formulate food-contact epoxy coatings.

BPA is precursor chemical used to manufacture bisphenol A diglycidyl ether (BADGE), a chemical compound of industrial significance. BADGE has been a conventional epoxy in the manufacture of materials and articles intended to come into contact with food products including water. Trace amounts of BPA if present after the manufacture of BADGE or residual within the final coating composition formulated using BADGE can potentially migrate from the coating into the food product.

In recent years, the European Chemicals Agency (ECHA) and the European Food Safety Authority (EFSA), among others, have placed specific migration limits (SML) on BPA when used as a monomer in the production of certain plastic material and prohibited its use as a precautionary measure in certain applications such as the production of infant feeding bottles. Accordingly, manufactures and consumers desire alternatives to BPA-containing materials but it has been challenging to find alternatives to BPA that can meet the performance requirements of the expected applications.

Adherent coatings, particularly those for large holding tanks, should preferably be liquid and capable of application to substrates having various contours. Such coatings should also have excellent adhesion to the substrate (e.g., metal), resist staining and other coating defects such as popping, blushing, blistering, and resist degradation over long periods of time, even when exposed to harsh environments or contents. In addition, coatings used with foodstuffs should be safe for food contact, and not adversely affect the taste of the food product. The coatings should also be capable of maintaining suitable film integrity during storage conditions, which may experience changes in operational temperatures, pressures, or content exposure.

In the United States, the Food & Drug Administration (FDA) regulates food-contact surfaces and coatings applied to such surfaces to ensure that these coatings are safe and comply with various FDA standards. One such standard is 21 C.F.R. § 175.300 (FDA 175.300), a regulation that specifies which resinous or polymeric materials may be safely used with the food-contact surface of articles intended for use in producing, manufacturing, packing, processing, preparing, treating, packaging, transporting, or holding food.

The selection of raw materials that may be used to formulate a coating compliant with FDA 175.300 is stringent and limited. Conventionally, FDA-compliant tank lining coatings may be hard or brittle. As a result, these coatings may be prone to cracking, especially when used on the inside of rail tank cars, where the coatings are subject to flexural strain and thermal expansion. Similarly, when a coating includes components (such as a curing agent, for example) that are sufficiently non-mobile to meet FDA standards, the coating is viscous to the point of requiring significant amounts of heat to be sprayable during application. Furthermore, a number of the methods and raw materials used to make a flexible FDA-compliant food-contact lining require a large input of energy (heat) to drive cure of the lining. In other words, changes made to a coating composition to achieve FDA compliance often result in the loss of a desirable coating performance characteristic such as flexibility, sprayability, or the ability to cure at ambient temperature.

From the foregoing, it will be appreciated that what is needed in the art is an FDA-compliant tank lining coating composition that can be sprayed at low temperature, that will cure at ambient temperatures, and that will remain flexible enough during the cure cycle and over its lifetime such that the coating does not crack and contaminate the stored or transported food commodity.

### SUMMARY

In some embodiments, this disclosure describes a two-part epoxy coating composition useful in a variety of coating applications, for example, as an adherent coating system. The adherent coating systems formulated from the two-part epoxy compositions disclosed would be of a kind suitable, but not limited to, protective coatings intended for potable water, large storage tanks, direct food contact applications, and the like. In preferred embodiments, the coating composition, which may be either liquid or solid, is sprayable and curable at ambient temperatures and demonstrates optimal flexibility while meeting the requirements of FDA 175.300.

In at least one embodiment, the coating composition described herein is a two-part coating composition for lining food-contact surfaces. The composition includes a first component and a second component. In an aspect, the first component includes at least one polyepoxide and the second component includes at least one amine curing agent capable of reacting with the polyepoxide under ambient conditions. The coating composition is sprayable at 25° C. or lower and demonstrates optimal flexibility.

In some embodiments, the present description provides a coated article. The article includes a substrate with at least one food-contact surface and a cured coating applied on the substrate. The cured coating is derived from a coating composition that includes a first component and a second component. In an aspect, the first component includes at least one polyepoxide and the second component includes at least one amine curing agent capable of reacting with the polyepoxide under ambient conditions. The coating composition applied to the substrate is sprayable at about 25° C. or less, and the cured coating is flexible.

In some embodiments, a system for storage or transport of a food commodity is described. The system includes a storage article that includes a metal or concrete substrate defining a food-contact surface, and an adherent coating on the food-contact surface. The adherent coating is derived from a two-part epoxy composition that includes a first component and a second component. In an aspect, the first component includes at least one polyepoxide and the second component includes at least one amine curing agent capable of reacting with the polyepoxide under ambient conditions. The system further includes a food-contact surface in direct contact with the adherent coating, where the adherent coating demonstrates optimal flexibility.

The disclosed two-part epoxy coating compositions may be useful in coating a variety of substrates, including, for example, storage articles and systems such as valves and fittings, pipes and transport lines, tanks and vessels (e.g., potable water tanks, oil tanks, hot fluid holding tanks, waste system tanks, and the like), and the like. As discussed further below, in preferred embodiments, the coating composition is useful as an adherent coating for large storage tanks holding hot liquids such as oil, water, or syrup; liquid food products; and the like.

In preferred embodiments, the coating composition is at least substantially free of mobile BPA or BADGE, and more preferably is completely free of BPA or BADGE. More preferably, the coating composition is at least substantially free, and more preferably completely free, of mobile or bound polyhydric phenols having estrogenic agonist activity greater than or equal to that of BPA or BPS.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise indicated, the term “polymer” includes both homopolymers and copolymers (i.e., polymers of two or more different monomers).

As used herein, the term “group” includes two or more atoms and is intended to be a recitation of both the particular moiety, as well as a recitation of the broader class of substituted and unsubstituted structures that includes the moiety.

A group that may be the same or different is referred to as being “independently” something. Substitution on the organic groups of the disclosed compounds is contemplated. As a means of simplifying the discussion of certain terminology used throughout this application, the terms “group” and “moiety” are used to differentiate between chemical species that allow for substitution or that may be substituted and those that do not allow for or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

As used herein, the term “aryl group” (e.g., an arylene group) refers to a closed aromatic ring or ring system such as phenylene, naphthylene, biphenylene, fluorenylene, and indenyl, as well as heteroarylene groups (e.g., a closed aromatic or aromatic-like ring hydrocarbon or ring system in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “arylene” or “heteroarylene” groups (e.g., furylene, pyridylene, etc.)

As used herein, the term “bound” when used in combination with one of the aforementioned phrases in the context, e.g., of a bound compound of a polymer or other ingredient of a coating composition (e.g., a polymer that is substantially free of bound BPA) means that the polymer or other ingredient contains less than the aforementioned amount of structural units derived from the compound. For example, a polymer that is substantially free of bound BPA includes less than 1,000 ppm (or 0.1% by weight), if any, of structural units derived from BPA.

As used herein, the phrase “consumable product” refers to a product intended for human or animal consumption. Consumable products may include solids, liquids, or a mixture of both. Consumable products may include, but are not limited to, water, natural oils (e.g., plant-based oils such as vegetable oil, corn oil, and the like), syrups, milk, and the like.

As used herein, the term “crosslinker” refers to a molecule capable of forming a covalent linkage between two or more molecules or between two different regions of the same molecule.

As used herein, the term “metal” in reference to materials used in an article substrate includes both elemental metals and alloy metals unless indicated otherwise.

As used herein, the term “cyclic group” means a closed ring hydrocarbon group that is classified as an alicyclic group or an aromatic group, both of which can include heteroatoms.

As used herein, the term “organic group” means a hydrocarbon group (with optional elements other than carbon and hydrogen, such as oxygen, nitrogen, sulfur, and silicon) that is classified as an aliphatic group, a cyclic group, or combination of aliphatic and cyclic groups (e.g., alkaryl and aralkyl groups).

As used herein, the term “phenylene” as used herein refers to a six-carbon atom aryl ring (e.g., as in a benzene group) that can have any substituent groups (including, e.g., hydrogen atoms, halogens, hydrocarbon groups, oxygen atoms, hydroxyl groups, etc.). Thus, for example, the following aryl groups are each phenylene rings: C₆H₄—, C₆H₃(CH₃)—, and C₆H(CH₃)₂Cl—. In addition, for example, each of the aryl rings of a naphthalene group are phenylene rings.

As used herein, the term “polyhydric phenol” (which includes dihydric phenols) as used herein refers broadly to any compound having one or more aryl or heteroaryl groups (more typically one or more phenylene groups) and at least two hydroxyl groups attached to a same or different aryl or heteroaryl ring. Thus, for example, both hydroquinone and 4,4′-biphenol are considered to be polyhydric phenols. As used herein, polyhydric phenols typically have six carbon atoms in an aryl ring, although it is contemplated that aryl or heteroaryl groups having rings of other sizes may be used.

Unless otherwise indicated, the term “molecular weight” refers to number average molecular weight (Mn). The molecular weight is expressed in Daltons (Da) and may be determined by standard methods known to those of skill in the art, preferably by size exclusion chromatography using universal calibration.

When the phrases “does not include any,” “free of” (outside the context of the aforementioned phrases), and the like are used herein, such phrases are not intended to preclude the presence of trace amounts of the pertinent structure or compound which may be present due to environmental contaminants.

The terms “a first,” “a second,” “a third,” and the like are used to distinguish between separate components and are not intended to imply a particular quantity or order unless described otherwise.

The term “comprises” and variations thereof do not have a limiting meaning where these terms appear in the description and claims.

The term “on” when used in the context of a coating applied on a surface or substrate, includes both coatings applied directly or indirectly to the surface or substrate. Thus, for example, a second coating applied to a first layer that overlies a substrate constitutes the second coating applied on the substrate. In comparison, the phrase “directly on” when used in the context of a coating applied directly on a surface or substrate, refers to the coating in direct contact with the surface or substrate without the presence of any intermediate layers or coatings there between.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In at least one embodiment, the present description provides a two-part epoxy coating composition that exhibits a lower estrogenic agonist activity compared to BPA-based coatings. The coating compositions may produce an adherent coating having comparable or better physical characteristics compared to BPA-based coatings including, for example, resistance to chemical attack, blistering, discoloration, or swelling, particularly when used with hot liquids such as oils, syrups, or other chemicals. Although the ensuing discussion focuses primarily on coating end uses such as interior coatings for storage articles (e.g., portable water tanks and the like), it is contemplated that the disclosed coating composition may have utility in a variety of other end uses. In particular, the two-part epoxy coating composition described herein, which may be either liquid or solid, is used as a tank lining coating that is sprayable and curable at ambient temperatures and demonstrates optimal flexibility while meeting the requirements of FDA 175.300.

The disclosed coating composition preferably a two-part epoxy that includes a first component comprising a polyepoxide (e.g., diepoxide) and a second component comprising one or more amine curing agents configured to react with the polyepoxide as described herein (i.e. as shown in Formula I below) under ambient or, if necessary, at low temperature curing conditions. The first and second components may each be independently a liquid or a solid.

As described further below, the polyepoxide may be derived from ingredients including a diepoxide having one or more hindered aryl or heteroaryl groups, and more preferably one or hindered ether phenylene groups described below (e.g., as depicted in Formula (I) below) and an amine or polyamine crosslinker. The two liquids of the coating compositions may be mixed together and coated onto a substrate surface to form at least a film-forming amount of the disclosed coating composition. The two-part liquid epoxy may be cured at under ambient conditions (e.g., room temperature, 25° C.) or under elevated temperature, or if necessary, at low temperature, i.e. lower than 25° C., preferably 5° C. to 25° C. Preferably, particularly for coating application of large articles, the two-part liquid epoxy is cured under ambient or low temperature conditions. The coating composition may also include one or more additional ingredients such as, for example, a liquid carrier, diluents, flexibilizers, pigments, fillers, and any other suitable optional additives that may or may not be included in the resultant polymer layer.

The disclosed coating compositions may exhibit a superior combination of coating attributes such as good substrate adhesion, good chemical resistance and corrosion protection, good fabrication properties, and a smooth and regular coating appearance free of blisters and other application or aesthetic-related defects. In some examples, the disclosed coating compositions exhibit improved coating attributes when used in storage articles (e.g., liquid holding tanks) compared to conventional BPA-based coatings. For example, the coating compositions may exhibit improved resistance against blistering and discolorization compared to BPA-based coatings when used to store hot liquids (e.g., oils, syrups, water, and the like having an average temperature of greater than 40° C.) and food based products. Additionally, or alternatively, the disclosed coating compositions may exhibit improved resistance to swelling or chemical attack compared to BPA-based coatings. While not intending to be bound by any theory, it is believed that the additional steric hindrance associated with the polyepoxide of Formula (I) provides additional resistance from heat related degradation of hot fluids as well as chemical attack. In addition to these attributes, the coating compositions disclosed herein may be either liquid or solid, and when used as a tank lining coating, the compositions are sprayable and curable at ambient or lower temperatures and demonstrate optimal flexibility while meeting the requirements of FDA 175.300.

In some embodiments, the coating composition described herein is a two-part epoxy composition that includes a first component that is a polyepoxide (e.g., diepoxide). In general, the ingredients used to make the two-part epoxy coating composition, in particular the polyepoxide, are preferably free of any dihydric phenols, or corresponding diepoxides (e.g., diglycidyl ethers), that exhibit an estrogenic agonist activity in an MCF-7 assay greater than or equal to that that exhibited by BPA in the assay. More preferably, the aforementioned ingredients are free of any dihydric phenols, or corresponding diepoxides, that exhibit an estrogenic agonist activity in the MCF-7 assay greater than or equal to that of BPS.

While not intending to be bound by any theory, it is believed that a dihydric phenol is less likely to exhibit any appreciable estrogenic agonist activity if the structure is sufficiently different from compounds having estrogenic agonist activity such as diethylstilbestrol. In some examples, this may be accomplished by using a polyepoxide derived from a polyhydric phenol that includes one or more hydroxyl groups present on each aryl ring of a polyhydric phenol compound (typically phenol hydroxyl groups of a dihydric phenol) that are sterically hindered by one or more other substituents of the aryl ring, as compared to a similar polyhydric phenol compound having hydrogen atoms present at each ortho and/or meta position. It is believed that it may be preferable to have substituent groups positioned at each ortho position relative to the aforementioned hydroxyl groups to provide optimal steric effect. It is also believed that the steric hindrance can prevent or limit the ability of a polyhydric phenol compound, and particularly a polyhydric phenol compound having two or more phenylene rings with hydroxyl groups, to act as an agonist for a human estrogen receptor.

As discussed above, the two-part epoxy coating composition includes a first liquid comprising a polyepoxide compound. Preferred polyepoxide compounds for use in the coating compositions are depicted in the below Formula (I):

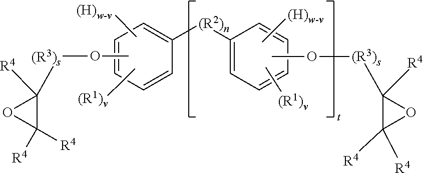

wherein:
each oxygen atom attached to phenylene groups in the formula is present in an ether or ester linkage;
each R1 is independently either hydrogen or a hydrocarbon group having an atomic weight of at least 15 Daltons;
v is independently 1 to 4;
n is 0 or 1, with the proviso that if n is 0, the phenylene groups depicted in the above formula can optionally join to form a fused ring system;
w is 4 or 3 if n is 0 and the phenylene groups form the fused ring system;
R2, if present, is preferably a divalent group;
t is 0 or 1;
two or more R1 groups or R1 and R2 groups can optionally join to form one or more cyclic groups;
s is 1;
R3, if present, is a divalent organic group;
each R4 is independently a hydrogen atom, a halogen atom, or a hydrocarbon group that may include one or more heteroatoms; and
the polyepoxide has an estrogenic agonist activity less than that of bisphenol S.

In some embodiments, the polyepoxide compound of Formula (I) is formed via epoxidation of a dihydric phenol compound (e.g., via a reaction using epichlorohydrin or any other suitable material). In some embodiments, R3 is a hydrocarbyl group, which may optionally include one or more heteroatoms. Preferred hydrocarbyl groups include groups having from one to four carbon atoms, with methylene groups being particularly preferred. The polyepoxides of Formula (I) may be made using any suitable process and materials. The use of epichlorohydrin in the epoxidation process is presently preferred. Preferred examples of polyepoxides of Formula (I) include, for example, a diepoxide formed via an epichlorohydrin epoxidation of 4,4′-methylenediphenol (also known bisphenol F or BPF), or 4,4′methylenebis(2,6-dimethylphenol) (also known tetramethyl bisphenol F or TMBPF). The resultant diepoxides are referred to as bisphenol F diglycidyl ether (BPF-DGE) or tetramethyl bisphenol F diglycidyl ether (TMBPF-DGE). In a preferred aspect, the polyepoxide used herein is BPF-DGE.

The polyepoxides of the first liquid may be prepared in a variety of molecular weights and viscosities. Increasing the molecular weight of the polyepoxide (e.g., via upgrading the epoxide) may also increase the viscosity of the fluid. In some examples, the viscosity of the fluid may be decreased with use of a solvent, but in preferred examples the amount of solvent used in the coating composition is relatively low (e.g., less than 10 wt-%) to reduce the amount of volatile organic compounds present. Preferred polyepoxides of Formula (I) may have a number average molecular weight (Mn) of about 100 to 10,000, preferably about 100 to about 500. Additionally, or alternatively, polyepoxides of Formula (I) may have a viscosity of about 5,000 poise to about 15,000 poise at 25° C.

Without limiting to theory, it is believed that BPF is a relatively small molecule which, when used as the sole source of epoxy groups in the ultimate polyepoxide, yields a brittle film because of the density of crosslinking. Accordingly, in a preferred aspect, and to significantly improve the flexibility of the coating composition, a small amount of the BPF-DGE, that makes up the first component of the coating composition is replaced by epoxidized soybean oil, i.e. a compound that adds flexibility, while retarding volatilization, extraction, and/or migration of mobile components. In a preferred aspect, about 1 to 25%, preferably about 5 to 20% by weight of the BPF-DGE is replaced by epoxidized soybean oil.

The epoxidized soybean oil used in the coating composition described herein is one of a variety of commercially available epoxidized soybean oil. Preferably, the epoxidized soybean oil is a low volatility, high molecular weight (Mn≈1000) compound that includes a long, flexible hydrocarbon chain between epoxy groups that remains flexible even after the crosslinking or curing reaction takes place. As a result, the ultimate coating demonstrates optimal flexibility while also meeting the requirements of FDA 175.300. Commercially available epoxidized soybean oils may be used, including for example, VIKOFLEX 7170 (Arkema). However, replacing too much, i.e. more than about 20 to 25% by weight of the polyepoxide of Formula (I) with epoxidized soybean oil may impair other important performance properties such as chemical resistance, for example.

As mentioned above, the two-part epoxy coating composition includes a second component comprising a curing agent configured to react with the polyepoxide of Formula (I) under ambient conditions. The choice of particular curing agent (e.g., crosslinking resins, sometimes referred to as “crosslinkers” may depend on the particular product being formulated. Preferred curing agents are food-safe and substantially free, and more preferably completely free, of mobile or bound BPA and BADGE. Additionally, due to the manufacturing constraints of coating large surfaces such as the interior of storage tanks, preferred curing agents are those that cure under ambient conditions, i.e. at 25° C. or lower, without the need to oven-bake the coated article.

In some embodiments, curing agents may include, but are not limited to, amine-based curing agents that react with the oxirane group under ambient conditions, i.e. at 25° C. or lower. Suitable amine-based curing agents may include polyamines (e.g., compounds having two or more oxirane-reactive amino groups); polyamide resins; mercaptans; and UV-curing agents. Examples of suitable polyamine curing agents may include, but are not limited to aliphatic amines (e.g., diethylenetriamine; diproprenediamine; triethylenetetramine (TETA); tetraethylenepentamine; and the like); amidoamines (e.g., curing agents available under the tradename ANCAMIDE available from Evonik Corp); cyclic amines (e.g., N-aminoethylpiperazine); cycloaliphatic amines (e.g., bis-(p-aminocyclohexyl (PACM) methane (e.g., curing agents available under the tradename ANCAMINE available from Evonik Corp); phenalkamines (e.g., curing agents available under the tradename CARDOLITE available from Cardolite Corp); phenalkamides (e.g., curing agents available under the tradename CARDOLITE 3040 available from Cardolite Corp); xylenediamines; derivatives thereof and the like. Examples of suitable polyamide resin curing agents may include, but are not limited to, curing agents available under the tradename ANCAMIDE 375A available from Evonik Corp. In some embodiments, the curing agents may include CARDOLITE NC541, CARDOLITE 3040, and TETA, or other agents that provide relatively short curing times.

Other curing agents that may be used with the two-part epoxy composition, though less preferred, include curing agents that react with the oxirane group at elevated temperatures. Such curing agents may include, for example, anhydrides; aminoplasts; dicyandiamides; blocked or unblocked isocyanates; latent curing agents; phenoplasts; certain polyamines (e.g., 2,2′-dimethyl-4,4′-methylenebis(cyclohexylamine) diaminodiphenylmethane, isophoronediamine, menthane diamine, metaphenylene diamine); or mixtures thereof. Due to the requisite heat needed to activate such curing agents (e.g., often exceeding 60° C.) they may be unsuitable for large applications such as large storage articles where it may not be possible to heat such large articles to the needed temperatures.

As discussed further below, various curing agents possessing different backbone chemistries (e.g., aliphatic, cycloaliphatic, etc.) were tested in with BPF-DGE in comparison to BADGE epoxies. BPF-DGE reacted well with all curing agents examined as did BADGE, albeit at a slower curing rates. Based on the studies, it is believed that conventional curing agents for BADGE are also suitable for the polyepoxides of Formula (I).

In a preferred embodiment, a blend of two or more amine-based curing agents is used in the coating composition described herein. A curing agent blend that includes two or more crosslinkers will provide both optimal cure/hardness and optimal flexibility for the ultimate coating. For example, one curing agent in the blend, typically a smaller molecule that provides tighter crosslinking density, may provide quick reaction time and low viscosity while imparting hardness to the coating. A second curing agent in the blend, typically a larger molecule that is more flexible, may provide lasting flexibility to the coating and also be more versatile with respect to cure temperature (i.e. ambient cure or low temperature cure) and cure duration.

Accordingly, in at least some embodiments, the curing agent component is a blend of two or more amine-based curing agents. An exemplary blend includes, without limitation a cycloaliphatic amine (e.g., commercially available as ANCAMINE 1618) and a phenalkamine (e.g., commercially available as CARDOLITE NC-541LV). The cycloaliphatic amine is cut in an alcohol such as benzyl alcohol, for example, while the phenalkamine is solvent-free. Blended together, these curing agents allow for rapid cure at ambient (i.e. 25° C.) or low temperatures while maintaining film integrity, i.e. providing optimal flexibility. Moreover, using this blend of curing agents, it is possible to achieve acceptable viscosity, which leads to optimal sprayability of the coating.

In at least some embodiments, the curing agent component is a 30:70 to 70:30 blend of a cycloaliphatic amine and a phenalkamine. In a preferred embodiment, the curing agent is a 30:70 to 40:60 blend of a cycloaliphatic amine and a phenalkamine.

Without limiting to theory, it is believed that a blend of curing agents provides a synergistic effect not seen using each curing agent independently. The cycloaliphatic amine, when used alone, would have yielded a cured coating that is too brittle/inflexible to be used as intended. Similarly, the solvent-free phenalkamine, when used alone, would require too much energy input to spray, and cure too slowly to be useful. In addition, the film integrity would have been poor, leading to potential (i.e. cracking of the coating) during use.

The level of curing agent or combination of curing agents used will typically depend on the type of curing agent, the number or relative reactive groups, the molecular weight of the polyepoxide, and the desired coating properties. In some embodiments, the curing agent or combination of curing agents may be combined in the coating composition at about a 0.6:1 to about a 1.2:1 stoichiometric ratio of curing agent to polyepoxide of Formula (I).

In at least one embodiment, the coating composition described herein further includes a diluent component. The diluent component is preferably a non-volatile, non-reacting, non-migrating component, preferably a liquid component. The diluent may be included in either the first component or the second component of the two-part epoxy composition described herein. Without limiting to theory, it is believed that the diluent will reduce the overall energy required to spray the coating composition at ambient temperature (i.e. 25° C.) or at lower temperatures (i.e. preferably 5° C. to 25° C.), because the diluent has plasticizing properties that contribute to the overall flexibility of the ultimate cured coating.

Exemplary diluents include, without limitation, polymeric polyester or monomeric ester plasticizers, such as esters of medium-chain carboxylics acids, including, for example, diesters of C₆ to C₁₆ dicarboxylic acid, preferably C₄ to C₁₁ dicarboxylic acid, including, but not limited to, diethyl sebacate, diisopropyl adipate, dibutyl sebacate, dibutyl adipate, and the like, or mixtures or combinations thereof. In a preferred embodiment, the diluent is dibutyl sebacate.

In some embodiments, one or both components of the two-part epoxy coating composition may include an organic solvent. Examples of suitable organic solvents include alcohols, aromatic or aliphatic hydrocarbons, dibasic esters, glycol ethers, ketones, esters, xylene, and the like, and combinations thereof. The solvent may help lower the viscosity of one or both of the liquids of the coating composition, or the resultant mixture for application, facilitate better mixing of the components, or slow the cure time of the mixture. In preferred examples, the coating composition is solvent-free or includes less than 20 wt-% solvent based on the total coating composition. Additionally, or alternatively, one or both of the liquids may include reactive diluents, co-resins known by those skilled in the art of formulating epoxy based coatings that can help lower the viscosity of the coating composition or the resultant mixture as needed.

In some embodiments, the coating composition may be characterized as a low VOC coating composition that preferably includes no greater than 0.4 kilograms per liter (kg/L) of volatile organic compounds (VOC) based on solids, more preferably no greater than 0.3 kg/L of solids, even more preferably no greater than 0.2 kg/L of solids, and optimally no greater than 0.1 kg/L of solids.

In some embodiments, the disclosed two-part epoxy coating composition may also include other optional ingredients that do not adversely affect the coating composition or a cured coating composition resulting therefrom. Such optional ingredients are typically included in a coating composition to enhance composition esthetics; to facilitate manufacturing, processing, handling, or application of the composition; or to further improve a particular functional property of a coating composition or a cured coating composition resulting therefrom. For example, the coating composition may optionally include adhesion promoters, anticorrosion agents, antioxidants, catalysts, colorants, defoamers, dyes, extenders, flow control agents, fillers, light stabilizers, lubricants, oxygen-scavenging materials, pigments, rheology control materials, toners, and mixtures thereof, as required to provide the desired film properties. Each optional ingredient is preferably included in a sufficient amount to serve its intended purpose, but not in such an amount to adversely affect the coating composition or a cured coating composition resulting therefrom.

Preferred compositions are substantially free of one or both of mobile BPA or mobile BADGE, and more preferably essentially free of these compounds, even more preferably essentially completely free of these compounds, and optimally completely free of these compounds. The coating composition (and preferably each ingredient included therein) is also preferably substantially free of one or both of bound BPA and bound BADGE, more preferably essentially free of these compounds, even more preferably essentially completely free of these compounds, and optimally completely free of these compounds. In addition, preferred compositions (and preferably each ingredient included therein) are also substantially free, more preferably essentially free, even more preferably essentially completely free, and optimally completely free of one or more or all of: bisphenol S, bisphenol F, and the diglycidyl ether of bisphenol F or bisphenol S.

The two-part liquid epoxy coating compositions may have utility in a variety of end uses, including industrial coatings; marine coatings (e.g., for ship hulls; interior tanks, portable water containers, cargo tanks, ballast tanks, and the like); coatings for product-contact surfaces of storage articles including but not limited to, valves and fittings; pipes and transport lines; tanks and vessels (e.g., portable water tanks, oil tanks, hot fluid holding tanks, waste system tanks, and the like); food processing systems; waste management systems; rail car tanks; refrigerated tanks; and the like. In some embodiments, coating compositions may be used for storage articles configured to hold or transport hot liquids (e.g., liquids having a temperature greater than 40° C.) such as water, oils, syrups, and the like, which may or may not also include consumable products. For example, the coating composition may be applied to outdoor storage tanks (e.g., portable water storage tanks and the like). The exposure of such tanks to the external environment may cause the contents stored within to heat to temperatures greater than ambient conditions (e.g., greater than 40° C.).

In preferred embodiments, the coating composition is suitable for use as an adherent coating for a product-contact surface of a storage article. The storage article may include a substrate such as metal (e.g., steel, aluminum, alloy, and the like); concrete; fiberboard; plastic (e.g., polyesters such as, e.g., polyethylene terephthalates; nylons; polyolefins such as, e.g., polypropylene, polyethylene, and the like; ethylene vinyl alcohol; polyvinylidene chloride; and copolymers thereof); glass-reinforced plastics; and the like. While metal and concrete are more commonly used materials for constructing holding tanks, plastics such as polyethylene or glass-reinforced plastics have also been useful in recent years. In some embodiments, the article may include a metal substrate.

As discussed above, the two-part epoxy coating composition may be particularly useful as an adherent coating for large storage articles (e.g., tanks) configured to hold or transport hot liquids or consumable products. In some embodiments, the storage article may define a product-contact surface that defines an area of greater than 1 square meter.

In a preferred embodiment, the two-part epoxy coating composition described herein is used as an adherent coating or lining for rail tank cars for the transport of liquid food commodities, such as high fructose corn syrup, for example. The two-part epoxy coating composition described herein is also useful as a lining material for stationary tanks (ambient cure-capable), hopper cars for dry food commodity transport, and the like.

Conventional FDA-compliant coatings that are currently available in the market for such food transport applications did not demonstrate optimal flexibility, particularly after exposure to heat. When a coating that is not flexible is exposed to high temperatures, the coating tends to crack, leading to contamination of the food product being transported, and subsequent costly buybacks. Surprisingly, and in contrast to existing coatings in the industry, the two-part epoxy coating composition described herein includes various components that work in tandem to yield a product that is surprisingly flexible for an epoxy-amine system and in consideration of the formulation limitations imposed by FDA standards, i.e. where all raw materials used must be compliant with FDA 175.300 or GRAS. Removing any of the components described herein (such as, removing epoxidized soy bean oil from the first component, or using just a single curing agent instead of a curing agent blend in the second component) compromises the flexibility of the system. In other words, key components of the coating composition work synergistically to provide an optimal combination of cure speed, viscosity, flexibility, and other performance characteristics.

The two-part epoxy coating composition may be applied to a desired article using any suitable technique. In preferred examples, particularly for application to large storage articles, the first and second liquids of the coating composition may be mixed and applied as a liquid to a surface of the article using a brush, roller, squeegee, trowel, spray application, or other suitable device. Once applied, the coating composition may be allowed to cure, preferably under ambient conditions without the need to oven-bake the article. In a preferred embodiment, the two-part epoxy coating composition described herein is applied to the substrate by spray application using methods known to those of skill in the art. A benefit of the coating composition described herein is that it may be sprayed at ambient or low temperatures without a significant increase in energy consumption.

In some embodiments, in order to exhibit a suitable balance of coating properties for use as a product-contact coating for large storage articles, the resultant adherent coating may have a glass transition temperature (Tg) suitable to impart a desired abrasion resistance or mechanical toughness depending on the end use. In some embodiments, the Tg of the coating may be greater than about 70° C. While not intending to be bound by theory, it is believed that it is important that the resultant adherent coating exhibit a Tg such as that described above in applications where the coating composition will be in contact with hot liquid materials (e.g., at temperatures at or above about 40° C.). Tg can be measured via differential scanning calorimetry (DSC) or Dynamic mechanical analysis (DMA) known to those in the art.

The disclosed two-part coating composition may be applied and cured to form layer of a mono-layer adherent coating or one or more layers of a multi-layer adherent coating system. Mono-layer or multi-layer adherent coatings may have any suitable overall coating thickness, but will typically have an overall average cured coating thickness of from about 25 to about 5000 micrometers and more typically from about 125 to about 1500 micrometers. In some embodiments, a storage article having the disclosed two-part epoxy coating composition disposed and cured on a surface of the article is provided that includes a stored product. In some embodiments, the stored product may be a hot liquid including, for example, oils (e.g., petroleum or natural oils), syrup, water, or other fluid or a consumable product. Additionally, or alternatively, the stored product may include a cosmetic product, a medicinal product, a waste product (e.g., human waste), or the like.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Missouri.

### Test Methods

Unless indicated otherwise, the following test methods were utilized in the Examples that follow.

### A. Mandrel Bend Test

The flexibility of a cured coating formed from the two-part epoxy compositions described herein is tested using the mandrel bend test according to NACE 0394 (Application, Performance, and Quality Control for Plant-Applied FBE External Pipe Coating) or according to ASTM D522 (Standard Test Method for Mandrel Bend Test of Attached Organic Coatings). Briefly, this test method is accomplished using a steel strap with a thickness of ¼ inch and a width of 1 inch. The strap is coated at the appropriate film thickness for testing. For the formulation in the Examples, the dry film thickness is in the rage of about 5 to 18 mil (approx. 125 to 450 μm). Once the coating is cured, these straps are flexed over a variety of radii using a long lever, with the radii functioning as the fulcrum. Results for the NACE method are reported as the smallest radii over which a prepared sample can be flexed without failure of the applied coating along with the dry film thickness of the coating.

The ASTM method involves application of the coating in question over a panel having a thickness of 0.032 inches (approx. 0.8 mm) at a given film thickness. Once cured, the panels are either (1) bent over a conical mandrel using a roller with a handle mounted perpendicular to the roller or (2) bent over a cylindrical mandrel by hand in a controlled, singular motion. The smallest diameter over which the coated panel was bent without cracking of the applied coating is the noted. Results for the ASTM method are expressed as the percent elongation the applied coating can stretch or flex before the film fails, typically by cracking. Alternately, the smallest diameter of mandrel at which the applied coating does not crack may be reported along with the thickness of the applied coating and the dimensions of the substrate.

### B. Direct/Reverse Impact Test

The direct and reverse impact resistance of cured coatings is tested using the methods described in ASTM D2794 (Standard Test Method for Resistance of Organic Coatings to the Effects of Rapid Deformation). Briefly, the coating to be tested is applied to a metal panel of a thickness previously agreed upon, most commonly, a 0.032-in (0.8 mm) thickness panel is used. Once cured, a 2 lb. weight (approx. 0.9 kg) with a hemispherical tip of ⅝-in (approx. 15.9 mm) diameter is dropped from a series of predetermined heights, measured in inches, onto the panel. “Direct impact” implies that the weight is dropped onto the coated face of the panel, resulting in a concave deflection when looking at the coated face. “Reverse impact” implies that weight has been dropped onto the back of the coated panel, resulting in a convex deflection when looking at the coated face. The impact resistance is noted as the greatest height from which the weight is dropped onto the panel, which does not result in cracking of the coating. Results are expressed as the weight dropped, i.e. 2 lb., multiplied by the distance travelled in inches, with the unit of measure being “inch-lb.”

### C. Dry Heat Resistance

The dry heat resistance of a coating indicates the ability of the coating to withstand elevated temperatures in typical service environments. The dry heat resistance of the coatings described herein is evaluated according to ASTM D2485 (Standard Test Methods for Evaluating Coatings For High Temperature Service). Test panels of dimensions that are common in the art are coated at a thickness appropriate for the coating and for a given end use. Once cured, the panels are placed into an oven set to the elevated temperature desired. After the temperature of the panels has equilibrated to the elevated temperature environment, the panels are removed from the oven after a given period of time. Once removed from the oven, the panels may be allowed to return to ambient temperature gradually or they may be quenched in water. This cycle is repeated as many times as desired. For the formulations in the Examples, 10 cycles were used. Failure would be determined by cracking, chalking, or some other loss of integrity of the coating. A passing result is the retention of the integrity of the coating, including no cracking or chalking.

### D. Sag Resistance Test

Sag resistance is a measure of the flow of the coating after application, as coatings or paints applied to slanted or vertical surfaces tend to sag or droop when first applied. The sag resistance of the coating compositions described herein is tested according to ASTM D4400 (Standard Test Method for Sag Resistance of Paints). This test procedure involves applying the coating to a Leneta chart using a gauged/notched applicator bar. Immediately following coating application, the chart is hung vertically until the applied coating has cured. The thickest line of applied coating that does not cross/sag into the line below it more than once is considered to be the limit of a coating's sag resistance and is reported in mils.

### E. Taber Abrasion Test

Taber abrasion or Taber resistance is a measure of a cured coating's resistance to abrasion, i.e. the ability of the coating to withstand mechanical action such as rubbing, scraping, or erosion. For the cured coatings described here, Taber abrasion is measured over 1000 cycles according to the method described in ASTM D4060 (Standard Test Method for Abrasion Resistance of Organic Coatings by the Taber Abraser). Results are reported in mg of coating lost over the specified number of cycles, with a lower number indicating a higher Taber resistance.

### F. Shore D Hardness

This is a test provides a measure of the hardness of a cured coating. The coatings described herein are tested using a specific indenter according to the methods described in ASTM D2240 (Standard Test Method for Rubber Property-Durometer Hardness). The hardness value is determined by the penetration of the Durometer indenter foot into a test sample of the coating.

### G. Acetic Acid Resistance

This test provides an indication of the chemical resistance of a cured coating. For the coatings described herein, the test involves holding acetic acid (1%) on a single face of a coated test panel using a cylindrical cell that has been clamped and sealed against the face of the panel. The entire apparatus is then placed into an elevated temperature environment (e.g., a chamber set to 49° C.) and the coated area in contact with the acetic acid is monitored for change over a given period of time (e.g., one month). Results are reported as pass (i.e. no change after acid exposure) or fail (i.e. surface shows blistering after acid exposure).

### H. Adhesion

This test is used to determine the adhesion of a cured coating to the substrate to which it has been applied. For the coatings described herein, adhesion is measured using a portable adhesion tester according to the methods described in ASTM D4541 (Standard Test Method for Pull-Off Strength of Coatings Using Portable Adhesion Testers). This test offers two test protocols. Protocol 1 (test to fracture) determines the greatest perpendicular force (in tension; psi) that a surface area can bear before a plug of material is detached. Protocol 2 (pass/fail) determines if the coated surface remains intact at a defined load criteria. For the coatings described herein, adhesion is reported using Protocol 1.

### I. Cure

This test is used to determine optimal cure properties of a coating composition. For the coating compositions described herein, cure properties are determined by measuring dry-to-touch (i.e. the length of time for a coating to dry where it can be touched with a finger without removing any coating), dry-hard (i.e. the length of time for a coating to dry through such that a coated article can be worked without removing any coating, used interchangeably with dry-to-handle, dry-through, dry-walk) according to ASTM D1640 (Standard Test Methods for Drying, Curing, or Film Formation of Organic Coatings). The tests are conducted under specified conditions of temperature and relative humidity, and at specific film thicknesses. Results are reported as the time taken to achieve a particular level of dryness.

### J. Potlife

For two-component coatings, potlife provides a measure of the working life of the composition after the components have been mixed. It is generally thought of as the length of time that a mixed coating system retains a viscosity low enough to still be capable of being sprayed or applied to a substrate. For the coatings described herein, potlife is measured by mixing the epoxy-containing component with the amine-containing component at the specified mix ratio in quantities that will yield a 15 fluid ounce sample. Once the resulting mixture either 1) converts to a solid or 2) becomes stringy and loses fluidity, the potlife is ended. Potlife is typically reported as the time taken for the mixture to lose fluidity.

### Example 1. Preparation of Coating Composition

Two-part epoxy coating compositions as described herein were prepared as follows. A first component including bisphenol F glycidyl ether (BPF-DGE; molecular weight of approximately 170 g/mol) and epoxidized soybean oil (molecular weight of approximately 230 g/mol) was mixed with a second component including a blend of aliphatic amine (amine equivalent weight of approximately 115 g/mol) and phenalkamine (amine equivalent weight of approximately 125 g/mol). The two components are combined at a stoichiometry of 1.15:1 (overindexed in favor of epoxy) to give the two-part epoxy coating composition.

### Example 2. Performance Testing

Various performance properties of the two-component coating formulation prepared in Example 1 were tested according to standard methods described herein. The coating composition of Example 1 was applied to steel test samples at a dry film thickness of about 8 to 15 mil (approx. 200 to 380 μm), and tested for various properties, as shown in Table 1. For comparison, cure and performance testing results for two commercially available coating compositions, designed Comparative #1 and Comparative #2, are also shown in Table 1.

TABLE 1
Performance Characteristics

| Performance | | | | | | |
|---|---|---|---|---|---|---|
| Characteristic | Example 1 | | Comparative #1 | | Comparative #2 | |
| Flexibility | 5.0% | | 4.9% | | 1.8% | |
| (mandrel bend) | | | | | | |
| Direct and | 22 in-lb Direct | | 50 in-lb direct | | 16 in-lb direct | |
| Reverse impact | 1 in-lb Reverse | | 4 in-lb reverse | | Failed reverse | |
| Dry heat | Pass/no cracking | | Pass/no cracking | | Pass/no cracking | |
| resistance | | | (became rough after | | | |
| | | | heat exposure) | | | |
| Sag resistance | Ambient | Heated | Ambient | Heated < | Ambient | Heated |
| | 30+ | 30+ | 20 | 12 | 30 | 30 |

| | | | |
|---|---|---|---|
| Taber abrasion | 124.9 mg | 102.4 mg | 69.8 mg |
| (1000 cycles) | | | |
| Shore D hardness | 75 | 77 | Film does not build |
| | | | enough to test |
| Acetic Acid | Passed (1 month, | Failed (1 month, | Failed (1 month, |
| resistance | 120 F.) | 120 F.; blistering) | 120 F.; blistering) |
| Adhesion | >3847 psi | 1834 psi | 1793 psi |

### Example 3. Cure Characteristics

In order to determine the cure characteristics of the two-component compositions described herein, the formulation of Example 1 was applied to steel test samples at a dry film thickness of about 8 to 15 mil (approx. 200 to 350 μm), and the time for various degrees of drying was measured according to standard methods described herein. Similarly, to determine the pot life of the coating compositions described herein, pint-sized samples of the mixed formulations were prepared as described in Example 1. The samples were used to determine potlife according to the method described herein. Results are shown in Table 2, along with results for two commercially available coating compositions, Comparative #1 and Comparative #2.

TABLE 2
Cure/Dryness Characteristics

| Dry Time | | | | | | | | | | | | | | | |
|---|---|---|---|---|---|---|---|---|---|---|---|---|---|---|---|
| Test (77 F.; | Example 1 | | | | | | Comparative #1 | | | | Comparative #2 | | | | |
| 50% RH) | 4.5*C. | | Amb. | | 60*C. | | 4.5*C. | Amb. | 60*C. | | 4.5*C. | | Amb. | | 60*C. |
| Dry-to- | <36 | h | 2 | h | 2 | h | <24 h | >3 h | 1 | h | <36 | h | 2 | h | 2.5 h |
| touch | | | | | | | | | | | | | | | |
| Dry-hard | <7 | days | <20 | h | <4 | h | >56 h | <8 h | 2.5 | h | <7 | days | <20 | h | 5.5 h |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A two-part coating composition for food-contact lining, comprising:
a first component comprising at least one polyepoxide; and
a second component comprising an amine curing agent capable of reacting with the polyepoxide under ambient conditions,
wherein the coating composition is flexible and sprayable at about 25° C. or less.

2. The coating composition of claim 1, wherein the amine curing agent is a blend comprising
a cycloaliphatic amine component; and
a phenalkamine component.

3. The coating composition of claim 1, wherein the at least one polyepoxide is derived from a diglycidyl ether of bisphenol-F.

4. The coating composition of claim 1, wherein the at least one polyepoxide is partially replaced by epoxidized soybean oil.

5. The coating composition of claim 1, wherein the coating is compliant with FDA standard 175.300.

6. The coating composition of claim 1, wherein the first component further includes a non-migrating flexibilizer.

7. The coating composition of claim 1, wherein the second component further includes a non-migrating flexibilizer.

8. The coating composition of claim 1, wherein the non-migrating flexibilizer is dibutyl sebacate.

9. The coating composition of claim 1, wherein the coating composition is flexible and sprayable at temperatures of about 5° C. to 25° C.

10. The coating composition of claim 1, wherein the coating composition is flexible and sprayable at temperatures of about 10° C. to 15° C.

11. A coated article, comprising:
a substrate with at least one food-contact surface;
a cured coating applied on the substrate, the cured coating derived from a coating composition comprising:
a first component comprising at least one polyepoxide; and
a second component comprising an amine curing agent capable of reacting with the polyepoxide under ambient conditions,
wherein the coating composition is sprayable at about 25° C. or less, and the cured coating is flexible.

12. The coated article of claim 11, wherein the substrate is part of a storage or transport system for a food commodity.

13. The coated article of claim 11, wherein the substrate is part of a storage or transport system for a liquid food commodity.

14. The coated article of claim 11, wherein the substrate is part of a storage or transport system for a solid food commodity.

15. The coated article of claim 11, wherein the substrate is part of a storage or transport system selected from rail tank cars, stationary tanks, hoppers, and combinations thereof.

16. (canceled)

17. (canceled)

18. A system for storage or transport of a food commodity comprising:
a storage article comprising a metal or concrete substrate defining a food-contact surface;
an adherent coating on the food-contact surface, wherein the adherent coating is derived from a two-part epoxy composition comprising:
a first component comprising at least one polyepoxide; and
a second component comprising an amine curing agent capable of reacting with the polyepoxide under ambient conditions; and
a food commodity in direct contact with the adherent coating.

19. The system of claim 18, wherein the storage article comprises one or more of a tank, a pipe, or a valve.

20. The system of claim 18, wherein a food-contact surface of the storage article defines a surface area of at least 1 square meter.

21. The system of claim 18, wherein the food commodity is a liquid.

22. The system of claim 18, wherein the food commodity is a solid.
